(19) United States
(12) Patent Application Publication
(10) Pub. No.: US 2015/0245738 A1
(43) Pub. Date: Sep. 3, 2015

(54) AUTOMATIC AND PROGRAMMED PROCESS OF GRILLING FOOD IN A TUBULAR MATRIX

(71) Applicant: CLEVER ACTION-LDA, Santo Tirso (PT)

(72) Inventor: Jorge Carvalho, Santo Tirso (PT)

(21) Appl. No.: 14/347,643

(22) PCT Filed: Jan. 16, 2014
(86) PCT No.: PCT/IB2014/058333

§ 371 Date: Mar. 27, 2014

(30) Foreign Application Priority Data
Jan. 19, 2013 (PT) 106745

(51) Int. Cl. A47J 36/32; A47J 37/06; A23L 1/01

(52) U.S. Cl. CPC A47J 36/32; A23L 1/0128; A47J 37/06; A23V 2002/00

(57) ABSTRACT

The present invention describes both a process and its respective equipment (1) needed to form and grill, in an automatic programmed mode, food pieces in a tubular matrix (10), from simple or combined food, previously crushed or reduced to pieces of a size inferior to 8×8 mm, those pieces being simultaneously grilled in both perimeter surfaces, by radiation of two electrical resistances, one in the inner perimeter (4) and the other in the outer perimeter (6), and that after being grilled, are extracted directly to the interior of a bread (15) forming a sandwich or to a plate (12) to be served at the table.

Technical Domain/Industrial application: The present innovation fits into the general domain of food catering and the specific domain of processes and equipment to grill food in an automatic programmed mode, thereby having application in the food and catering industry.

### TECHNICAL DOMAIN OF THE INVENTION

The present invention fits into the general domain of food catering and the specific domain of processes and equipment to grill food in an automatic programmed mode and comprehends:

The programmed automatic process to form and grill pieces of food in a tubular matrix (10), from solid food previously crushed or reduced to pieces smaller than 8×8 mm, simple or combined, in which the pieces of food in a tubular matrix (10) are grilled simultaneously on both perimeter surfaces by radiation of two independent electrical resistances an inner perimeter (4) and an outer perimeter (6), which after grilled is then extracted into a bread (15) forming a sandwich or a plate (12), to be served at the table.
The inter-related electromechanical to undertake the process of forming and grilling the food in a tubular matrix in an automatic and programmed manner made up of: —An electronic device (1) that incorporates a specific program that is provided with an electronic printed circuit board and additional electronic devices that select, manage, control and command all the process in terms of the data recorded on file about the food likely to be grilled provided by the user, all the process of forming and grilling single part solid food of a tubular matrix (10), namely the temperatures of the two electrical perimeter resistances, one inner perimeter (4) and the other in the outer perimeter (6) and the respective exposure times, as well as, the movements, routes and performance times of the two electrical operators, one revolving (3) and the other linear (5) that act in the process; a drum (2) equipped with cylindrical orifices with matching dimensions to the food parts of a tubular matrix single portion (10) and a longitudinal cavity with the length and diameter corresponding to the spindle (18) of the electrical revolving operator (3) where it fits and is held there by a quick fastening lock bolt (14), incorporated in the electrical revolving operator (3) where the tubular pieces of food of a single portion are formed from solid food previously crushed or reduced to pieces smaller than 8 mm, these being formed by action of a Pre forming male (11) external to the electromechanical device set up with an identical diameter base to the diameter of the said movable drum (2) and the cylindrical pins in the same number and length of the orifices of the said moveable drum (2) concentric to them and with a diameter of at least two centimeters smaller than the diameter of the said holes in moveable drum (2), in case it is intended to freeze the pieces for later processing or, at the time, in case it is intended to grill pieces of food of a tubular matrix of a single portion (10), made up of solid food, simple or combined, crushed or reduced to pieces of maximum dimensions of 8×8 mm and introduced in the orifices of the moving drum (2) through the compression exerted in the food jointly by the inner electrical perimeter resistance (4) and the plunger (9), actioned by the movement of an electrical linear operator (5); A Pre forming Male (11) to, if wanted, previously pre form the tubular matrix of the food to be grilled (10) made up of solid food, simple or combined crushed or reduced to pieces of a maximum dimension of 8×8 mm and introduced into the orifices of a movable drum (2) through the compression exerted on them manually with a pre forming male (11) an electrical revolving operator (3), with a shaft (18) and a fitting system (14) associated, where the Drum (2) is fixed, which rotates in accordance to the value of the angle formed by the drum's orifices, aligning the pieces of food to be grilled with the grill tube (13); —a plunger (9) that together with the inner electrical perimeter resistance (4), by action of an electrical linear operator (5), moves to, first form and/ or collect in the Drum (2), the food part to be grilled and transport it to the grilling area, compressing it while it grills against the retention scissors (7) and after being grilled extracts it directly onto the interior of a bread (15) or a plate (12); —A grilling tube (13), that is used as a guide for the transport of the part to be grilled, to the incorporated outer perimeter electrical resistance (6), where it is grilled; An inner perimeter electrical resistance (4), that together with the plunger (9), actioned by the advance of the electrical linear operator (5) forms and/or collects the part to be grilled in the Drum (2) and transports it to the grilling area, where it is grilled through its inner perimeter surface by this resistance and following the grill it is extracted; —An outer perimeter electrical resistance (6) incorporated in the grilling tube (13) to grill the external perimeter surface of the food; —A retention scissor (7), which moves along a structural guide (19), which is closed to retain and compress the piece to be grilled and when grilled, it opens with the advance of the electrical linear operator (5) to extract it, closing itself when the operator retreats by means of a mechanical closing spring (20), to retain the grilled part in a bread (15) or a plate (12); —A collection tray (8) to recover the grilled part which is moved by the impulse of a shaft (17), actioned by the movement of the linear operator (5).

This process and its respective equipment may be used at any catering establishment, as well as in people's homes, given the high level of programming and automation of the new technology it does not need any specialized knowledge of culinary arts.

### INVENTION BACKGROUND/STATE OF THE ART

There are several processes, methods, techniques, equipments and kitchen utensils, namely pots, ovens, fryers and other recipients where it is possible to bake, fry or roast, simple or combined food, some with molded shapes similar to the tubular form described in the process above, namely cakes, pies, stuffed or filled foods and others but all of them prepare food with liquids, semi liquids or semi solids and because of that they only bake, fry or roast them and do not grill them as in the process above. Among these processes, methods, equipments and kitchen utensils that can only bake, fry or roast we highlight the process described in U.S. patent 2011/0252978 A1 issued on the 11 Aug. 2008 in favor of Alva V. Courtright which allows food to be prepared in several decorative forms namely in a similar manner to that described above but this process does not permit food to be grilled, nor does it use a similar process or equipment like those described in this invention; U.S. Pat. No. 4,353,929 issued on the 12 Oct. 1981 in favor of Three Rivers Development Corporation in respect of an equipment that allows to cook compact food, but not tubular, normally sausages or other filled/stuffed foods which, for that reason also only uses external electrical resistances. Therefore this technology does not form or grill foods in a tubular matrix, it neither uses a technique, nor a process, nor similar equipment to those revealed above as the final product prepared is radically different.

There are also several other processes, methods, equipments and kitchen utensils known, such as grills, barbecues, hot plates and presses and other electrical equipment that grill solid, simple or combined food in various forms (Ex:. meat on a spit, filled/stuffed, patties), in close contact with fire or electrical resistances, some with pre regulated temperature control and grilling times, but all of them up to now using compact forms of food, never of a tubular matrix and therefore only use a resistance to grill them unlike the process described above that simultaneously grills both perimeter surfaces of the tubular part through two electrical resistances: an inner and an outer one, additionally none of these processes, methods or equipments known use processes, structures, techniques and equipment, dynamics and processing modes similar to those revealed. Among the processes, methods, equipments and existing kitchen utensils that grill food we highlight the described in U.S. Pat. No. 4,077,311 issued on the 7 Mar. 1978 in favor of Kenneth L. Wormack that refers to a device that allows to grill food in series using a transport conveyor belt and several external resistances which has nothing to do with the process, equipment and processing revealed here; U.S. Pat. No. 3,064,555 issued on the 20 Nov. 1962 in favor of Frank S. Nanna which refers to a machine that automatically forms food in a compact cylinder and then cuts it in the shape of patties (hamburgers), and then grills them solely using external resistances. This technology is also intended to grill a distinct product, in this case hamburgers, by using a different process and equipment from those revealed above; U.S. Pat. 3,116,680 issued on the 7 Jan. 1964 in favor of Arthur E. Neamann that describes an equipment to grill pieces of meat in a cylindrical and compact shape inside a rotating tube associated to an electromechanical equipment, but only using a single resistance unlike the process and equipment above revealed which forms pieces of a tubular shape and grills them simultaneously in both perimeter surfaces through two electrical resistances: one inner and the other outer, as well as the method, technique, process, structure, equipment, dynamics and processing mode and respective final product are completely distinct.

In the current state of the art there is no process or equipment, described or known that forms and grills food in a tubular shape simultaneously in both perimeter surfaces which is similar to the process and equipment here disclosed.

The present invention satisfies the needs and wishes of the market either of the industry and fast food catering services or of the domestic market that wishes to prepare grilled food to form sandwiches or dishes, according to own recipes in a programmed and automatic manner and in a quick, easy and effective way.

The high level of automated programming and the interactive processing offered by the new process enable any person to use it without the need to have special knowledge of culinary skills, it is sufficient to identify the food that is intended to be grilled and the program automatically selects, manages and controls its processing.

### BRIEF DESCRIPTION OF THE FIGURES

FIG. 1 shows a perspective view of all the equipment, in which:
1—Electronic device with a specific program
2—Drum
3—Electric revolving operator
4—Inner perimeter electrical resistance
5—Electrical linear operator
6—Outer perimeter electrical resistance
7—Retention scissors
8—Collection tray

FIG. 2 shows a perspective view of the Electronic System (1) with an incorporated own program that selects, manages, controls and commands the whole automatic process.

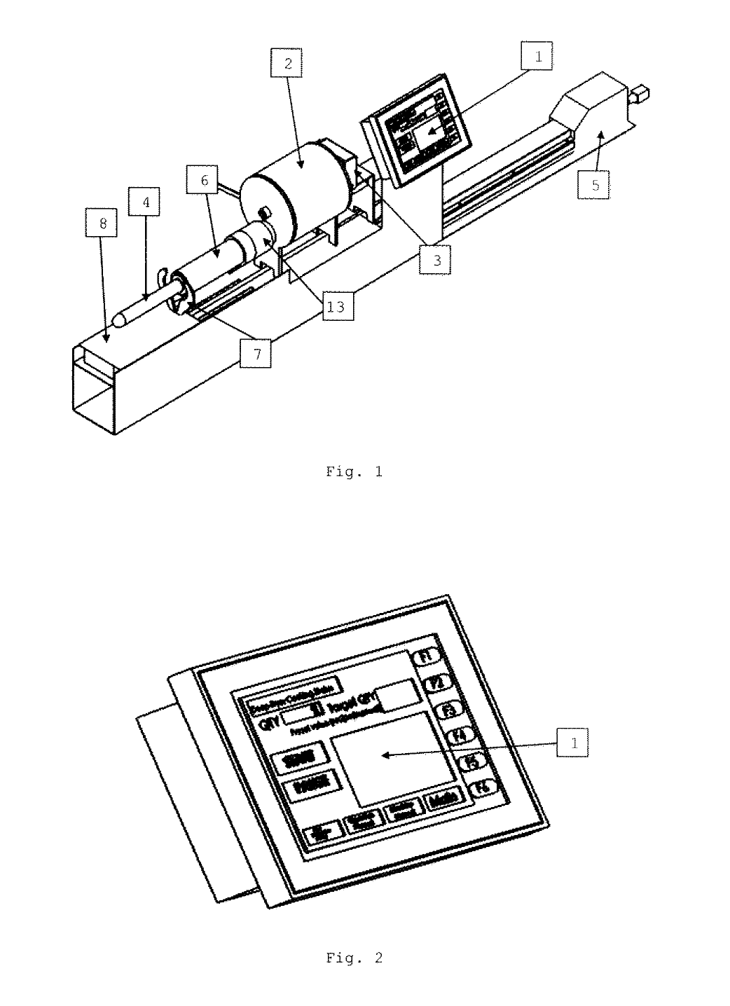

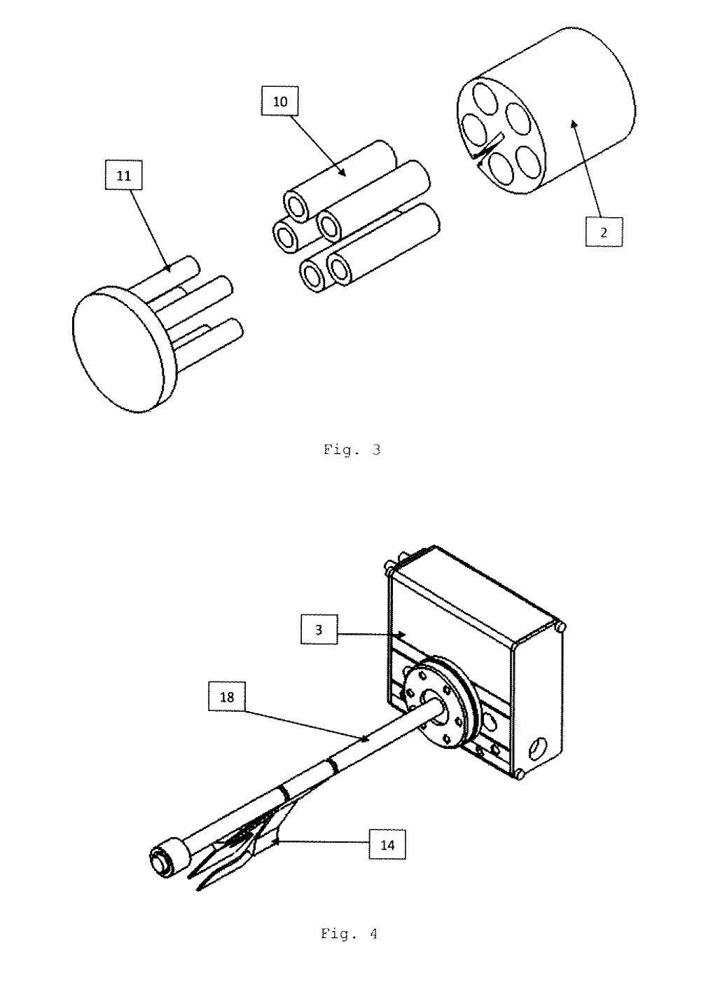

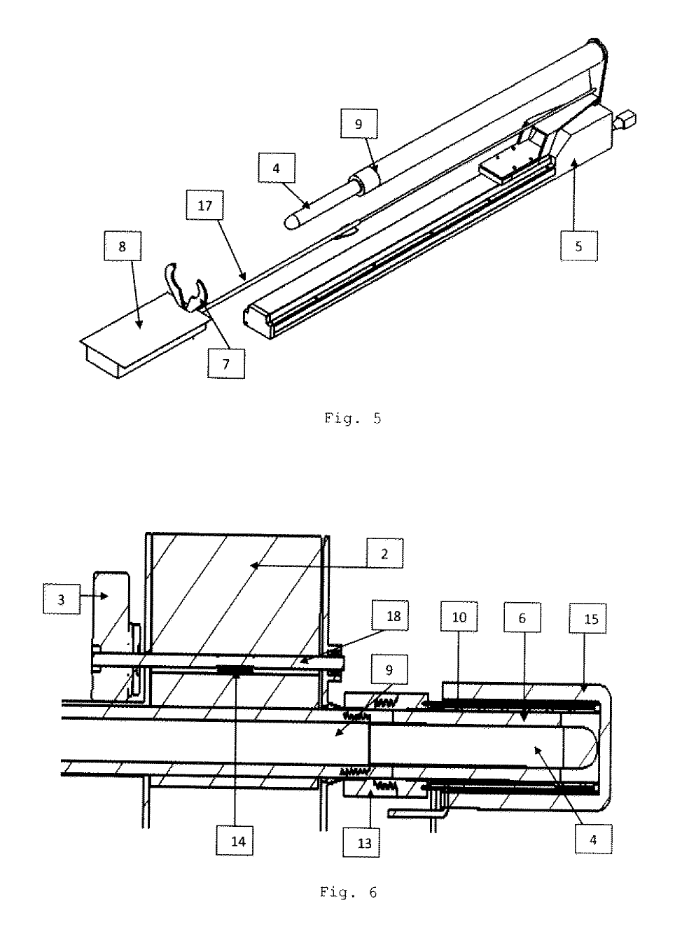

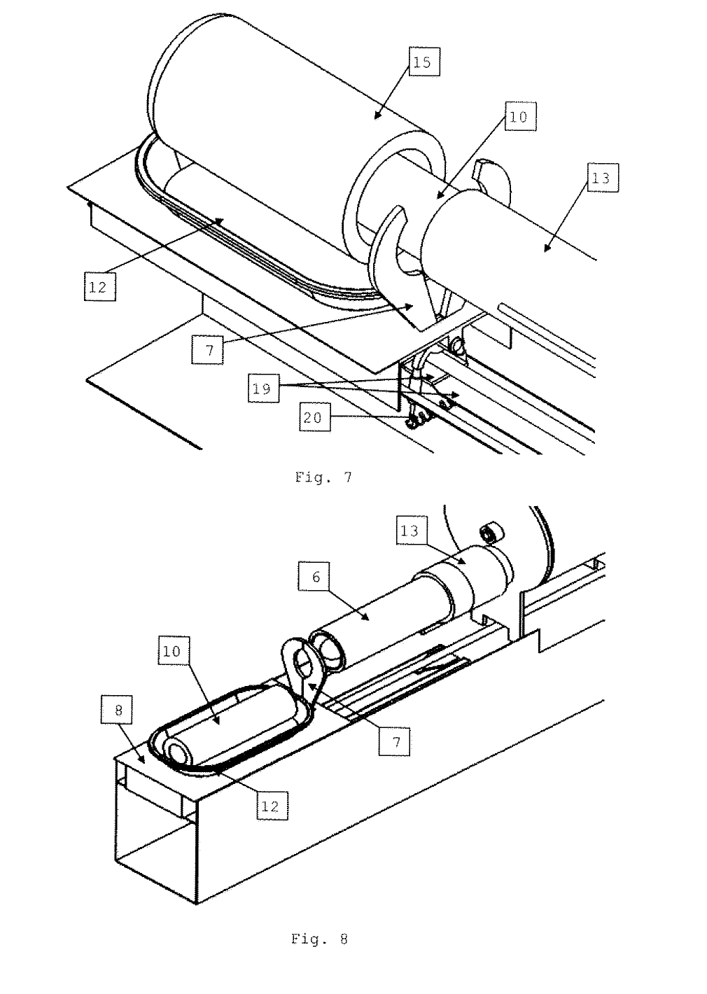

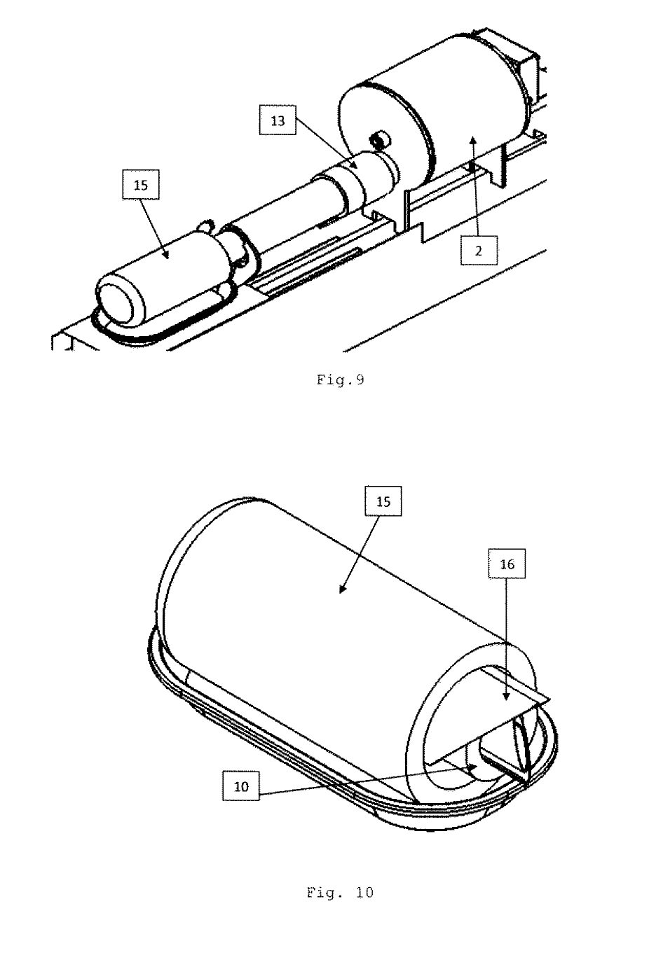

FIG. 3 shows a perspective view of the Pre Forming tubular food part, in which:
2—Drum
11—Pre Forming Male
10—Tubular food part

FIG. 4 shows a perspective view of the Electric revolving operator, with the shaft and fitting system to the Drum, in which:
3—Electric revolving operator
18—Axis of the Electric revolving operator
14—Quick Fastening Lock Bolt

FIG. 5 shows a perspective view of the transmissions associated to the Electrical linear operator and the elements that drive it, in which:
5—Electrical linear operator
4—Inner perimeter electrical resistance
9—Plunger
7—Retention scissors
17—Transmission shaft of the collection tray
8—Collection tray

FIG. 6 shows a selected view of the equipment in which:
2—Drum
3—Electric revolving operator
18—Shaft of the Electric revolving operator
14—Quick Fastening Lock Bolt
9—Plunger
4—Inner perimeter electrical resistance
13—Grilling tube
6—Outer perimeter electrical resistance
10—Tubular food part
15—Bread

FIG. 7 shows a perspective view of the closing system of the retention scissors coupled to the collection tray to receive the grilled food part, in which:
4—Inner perimeter electrical resistance
9—Plunger
7—Retention scissors
19—Structural guide to open the retention scissors
20—Mechanical spring to close the retention scissors
8—Collection tray

FIG. 8 shows a perspective view at the end of the automatic grilling process with the direct extraction of the part directly to a plate, in which:
13—Grilling tube
6—Outer perimeter electrical resistance
7—Retention scissors
8—Collection tray
10—Tubular food part
12—Plate

FIG. 9 represents a perspective view of the formation of a sandwich, in which:
2—Drum
13—Grilling tube
15—Pre formed bread

FIG. 10 represents a perspective view of a formed sandwich containing in its interior the grilled part, where additionally and as an example lettuce leafs are served as a complement.
15—Bread
10—Tubular food part
16—Another food item (Ex:. Lettuce)

### DETAILED DESCRIPTION OF THE INVENTION

The invention discloses a process of forming and grilling a piece of food of a single portion of a tubular matrix 10, from the exclusive use of solid foods, simple or combined, crushed or reduced to pieces of a maximum dimension of 8×8 mm, in the using the electromechanical equipment to form and grill food according to claim 1.

The electromechanical equipment to form and grill food according to claim 1 consists of the following components:
A moveable drum 2 equipped with cylindrical orifices with the same dimensions of the measurements of the pieces of food of a single portion of a tubular matrix 10 and a longitudinal cavity to the length and diameter equal to the shaft 18 and the electric revolving operator 3, where it fits and is held there by a quick fastening lock bolt 14, incorporated in the electrical revolving operator 3.
A pre forming male 1 external to the electromechanical device set up with an identical diameter base to the diameter of the said movable drum 2 and the cylindrical pins in the same number and length of the orifices of the said moveable drum 2, concentric to them and with a diameter of at least two centimeters smaller than the diameter of the said holes in moveable drum 2.
An electronic device 1 that incorporates its own computer program with data stored in files about the food likely to be grilled and the respective temperatures and adequate grilling times and an electronic printed circuit board and additional electronic devices, that command the electromechanical operations corresponding to the operating program selected by the IT program.
The said electrical revolving operator 3, provided with the aforementioned shaft (18) and the quick fastening lock bolt 14, where the said moveable drum 2 is inserted, that rotates in each start, the equivalent of the angle formed by the orifices of the said moveable drum 2, allowing the alignment of the pieces of food of a single portion of a tubular matrix 10 to be grilled in the grilling tube.
The grilling tube 13 with an equal diameter to the orifice of the said moveable drum 2, being a transport conveyor of the pieces of food of a single portion of a tubular matrix 10 to be grilled, from the said moveable drum 2 to its extraction.
An electrical linear operator 5 is connected to the support device of an inner electrical perimeter resistance 4 and a plunger 9 in a horizontal position parallel to the shaft from which are carried out the programmed forward, stop and reverse movements.
An inner electrical perimeter resistance 4 associated to the shaft of the electrical linear operator 5 in a parallel position of movement from the start to the end of the operation in accordance with all the movements transmitted by the said electrical linear operator 5, from which occurs the grilling operation destined by the program.
An outer perimeter electrical resistance 6 incorporated in the grilling tube 13 from which occurs the grilling operation destined by the program.
A retention scissor 7, equipped with a mechanical spring 20 to close the said retention scissor 7 and a structural guide 19, as required by the process.
A collection tray 8 equipped with a shaft 17 moved by action of the electrical linear operator 5 as required by the process,

To form and grill food that uses the equipment described in claim 1 has eight stages.

1) Exclusive use of solid foods, simple or 420 combined, crushed or reduced to pieces of a maximum dimension of 8×8 mm, in the process of forming and grilling a piece of food of a single portion of a tubular matrix 10.

2) Insertion of the said solid foods, simple or combined, crushed or reduced to pieces of a maximum dimension of 8×8 mm in the orifices of the moveable drum 2.

3) Previous formation of a piece of food of a single portion of a tubular matrix 10, made up of solid foods, simple or combined, crushed or reduced to pieces of a maximum dimension of 8×8 mm, and inserted in the orifices of the moveable drum (2) through the manual compression exercised by the pre forming male 11.

4) Formation of a piece of food of a single portion of a tubular matrix 10, made up of solid foods, simple or combined, crushed or reduced to pieces of a maximum dimension of 8×8 mm, and inserted in the orifices of the moveable drum 2 by the compression exerted jointly by the inner electrical perimeter resistance 4 and the plunger 9 auctioned by the movement of electrical linear operator 5.

5) Automatic process selection to form and grill solid foods simple or combined, crushed or reduced to pieces of a maximum dimension of 8×8 mm in a piece of food of a single portion of a tubular matrix 10, by the IT program inserted in the electronic device 1 according to data in files available and the information provided by the user about variety and quantity of food to be grilled inserted in the moveable drum 2.

(6) Ordering of the electromechanical operations corresponding to the operating program selected by the computer program through the electronic printed circuit board and additional electronic devices inserted in the electronic devices 1, namely:
The temperatures of the inner electrical perimeter resistance 4 and the outer perimeter electrical resistance 6 that should be applied,
The exposure times of the single portion of a tubular matrix 10, to the radiation of the said electrical resistances.
The movements, routes and performance times of the two electrical parts, namely the electrical revolving operator 3 and the electrical linear operator 5.

(7) Management, development and automatic control by an electronic device 1, of the grilling process of a single portion of a tubular matrix 10, in which:
The orifice or orifices of the moveable drum 2, are filled with the said food parts of a tubular matrix of a single portion 10 already formed or with solid foods, simple or combined, crushed or reduced to pieces of a maximum dimension of 8×8 mm inserted in its orifices to form them.
The moveable drum 2 is introduced in the shaft 18 of the electrical revolving operator 3 through the quick fastening lock bolt system 14, that rotates in each start, the equivalent of the angle formed by the orifices of the said moveable drum 2, to align the pieces of food of a single portion of a tubular matrix 10 with the grilling tube 13.
The said food parts of a tubular matrix of a single portion 10, inserted in the inner electrical perimeter resistance 4 and the associated plunger 9, is recovered from the drum by action of the advance of the electrical linear operator 5.
The said food parts of a tubular matrix of a single portion 10, after being recovered from the moveable drum 2, are transported in the same manner, inserted in the inner electrical perimeter resistance 4 and the associated plunger 9 to the grilling area, through the grilling tube 13, where the outer perimeter electrical resistance 6 is located.
The said food parts of a tubular matrix of a single portion 10, after being transported to the grilling area, remains there grilling, compressed against the retention scissor 7, closed for this purpose by action of the mechanical spring 20, that it has, for the time determined by the IT program incorporated in the electronic device 1.
The said food parts of a tubular matrix of a single portion 10, after being grilled is extracted, still inserted in the inner electrical perimeter resistance 4 and the associated plunger 9, by action of the advance of the electrical linear operator 5 which, to that effect triggers the structural guide for opening the scissor 19 to open the retention scissor 7.
The said food parts of a tubular matrix of a single portion 10, after being grilled, being collected to a bread, placed to involve the outer perimeter electrical resistance 6 when, and to that effect is issued an audible warning sign by the electronic device 1, at that time closing the retention scissor to impede the return of said food parts of a tubular matrix of a single portion 10 already grilled and extracted, and which can be retracted to a plate placed on a collection tray 8, closing the scissors at the time of retention to prevent the return of said food parts of a tubular matrix of a single portion 10.

8) the grilling of the food parts of a tubular matrix of a single portion 10 simultaneously along both perimeter surfaces, inner and outer, by radiation generated by two independent electrical resistances, one in the outer perimeter 6 and the other in the inner perimeter 4, whose temperatures and grilling times are determined, automatically, by the IT program, incorporated in the electronic device 1.

### INDUSTRIAL APPLICATION OF THE INVENTION

The invention hereby revealed has application in the catering trade and industry, mainly in the sector designed as “fast food”, as well as, in the preparation of food in the domestic sector.

1. Electromechanical equipment to form and grill food, which is characterized by comprising:
A moveable drum (2) equipped with cylindrical orifices with the same dimensions of the measurements of the pieces of food of a single portion of a tubular matrix (10) and a longitudinal cavity to the length and diameter equal to the shaft (18) and the electric revolving operator (3), where it fits and is held there by a quick fastening lock bolt (14), incorporated in the electrical revolving operator (3),
A pre forming male (11) external to the electromechanical device set up with an identical diameter base to the diameter of the said movable drum (2) and the cylindrical pins in the same number and length of the orifices of the said moveable drum (2), concentric to them and with a diameter of at least two centimeters smaller than the diameter of the said holes in moveable drum (2),
An electronic device (1) that incorporates its own computer program with data stored in files about the food likely to be grilled and the respective temperatures and adequate grilling times and an electronic printed circuit board and additional electronic devices, that command the electromechanical operations corresponding to the operating program selected by the IT program,
The said electrical revolving operator (3), provided with the aforementioned shaft (18) and the quick fastening lock bolt (14), where the said moveable drum (2) is inserted, that rotates in each start, the equivalent of the angle formed by the orifices of the said moveable drum (2), allowing the alignment of the pieces of food of a single portion of a tubular matrix (10) to be grilled in the grilling tube,
The grilling tube (13) with an equal diameter to the orifice of the said moveable drum (2), being a transport conveyor of the pieces of food of a single portion of a tubular matrix (10) to be grilled, from the said moveable drum (2) to its extraction,
An electrical linear operator (5) is connected to the support device of an inner electrical perimeter resistance (4) and a plunger (9) in a horizontal position parallel to the shaft from which are carried out the programmed forward, stop and reverse movements,
An inner electrical perimeter resistance (4) associated to the shaft of the electrical linear operator (5) in a parallel position of movement from the start to the end of the operation in accordance with all the movements transmitted by the said electrical linear operator (5), from which occurs the grilling operation destined by the program,
An outer perimeter electrical resistance (6) incorporated in the grilling tube (13) from which occurs the grilling operation destined by the program,
A retention scissor (7), equipped with a mechanical spring (20) to close the said retention scissor (7) and a structural guide (19), as required by the process,
A collection tray (8) equipped with a shaft (17) moved by action of the electrical linear operator (5) as required by the process.

2. To form and grill food that uses the equipment described in claim 1 characterized by the following stages:
a) Exclusive use of solid foods, simple or combined, crushed or reduced to pieces of a maximum dimension of 8×8 mm, in the process of forming and grilling a piece of food of a single portion of a tubular matrix (10),
b) Insertion of the said solid foods, simple or combined, crushed or reduced to pieces of a maximum dimension of 8×8 mm in the orifices of the moveable drum (2),
c) Previous formation of a piece of food of a single portion of a tubular matrix (10), made up of solid foods, simple or combined, crushed or reduced to pieces of a maximum dimension of 8×8 mm, and inserted in the orifices of the moveable drum (2) through the manual compression exercised by the pre forming male (11),
d) Formation of a piece of food of a single portion of a tubular matrix (10), made up of solid foods, simple or combined, crushed or reduced to pieces of a maximum dimension of 8×8 mm, and inserted in the orifices of the moveable drum (2) by the compression exerted jointly by the inner electrical perimeter resistance (4) and the plunger (9) auctioned by the movement of electrical linear operator (5),
e) Automatic process selection to form and grill solid foods simple or combined, crushed or reduced to pieces of a maximum dimension of 8×8 mm in a piece of food of a single portion of a tubular matrix (10), by the IT program inserted in the electronic device (1) according to data in files available and the information provided by the user about variety and quantity of food to be grilled inserted in the moveable drum (2),
(f) Ordering of the electromechanical operations corresponding to the operating program selected by the computer program through the electronic printed circuit board and additional electronic devices inserted in the electronic devices (1), namely:
The temperatures of the inner electrical perimeter resistance (4) and the outer perimeter electrical resistance (6) that should be applied,
The exposure times of the single portion of a tubular matrix (10), to the radiation of the said electrical resistances,
The movements, routes and performance times of the two electrical parts, namely the electrical revolving operator (3) and the electrical linear operator (5),
(g) Management, development and automatic control by an electronic device (1), of the grilling process of a single portion of a tubular matrix (10), in which:
The orifice or orifices of the moveable drum (2), are filled with the said food parts of a tubular matrix of a single portion (10) already formed or with solid foods, simple or combined, crushed or reduced to pieces of a maximum dimension of 8×8 mm inserted in its orifices to form them,
The moveable drum (2) is introduced in the shaft (18) of the electrical revolving operator (3) through the quick fastening lock bolt system (14), that rotates in each start, the equivalent of the angle formed by the orifices of the said moveable drum (2), to align the pieces of food of a single portion of a tubular matrix (10) with the grilling tube (13),
The said food parts of a tubular matrix of a single portion (10), inserted in the inner electrical perimeter resistance (4) and the associated plunger (9), is recovered from the drum by action of the advance of the electrical linear operator (5),
The said food parts of a tubular matrix of a single portion (10), after being recovered from the moveable drum (2), are transported in the same manner, inserted in the inner electrical perimeter resistance (4) and the associated plunger (9) to the grilling area, through the grilling tube (13), where the outer perimeter electrical resistance (6) is located,
The said food parts of a tubular matrix of a single portion (10), after being transported to the grilling area, remains there grilling, compressed against the retention scissor (7), closed for this purpose by action of the mechanical spring (20), that it has, for the time determined by the IT program incorporated in the electronic device (1),
The said food parts of a tubular matrix of a single portion (10), after being grilled is extracted, still inserted in the inner electrical perimeter resistance (4) and the associated plunger (9), by action of the advance of the electrical linear operator (5) which, to that effect triggers the structural guide for opening the scissor (19) to open the retention scissor (7)
The said food parts of a tubular matrix of a single portion (10), after being grilled, being collected to a bread, placed to involve the outer perimeter electrical resistance (6) when, and to that effect is issued an audible warning sign by the electronic device (1), at that time closing the retention scissor to impede the return of said food parts of a tubular matrix of a single portion (10) already grilled and extracted, and which can be retracted to a plate placed on a collection tray (8), closing the scissors at the time of retention to prevent the return of said food parts of a tubular matrix of a single portion (10),
h) the grilling of the food parts of a tubular matrix of a single portion (10) simultaneously along both perimeter surfaces, inner and outer, by radiation generated by two independent electrical resistances, one in the outer perimeter (6) and the other in the inner perimeter (4), whose temperatures and grilling times are determined, automatically, by the IT program, incorporated in the electronic device (1).
